(19) United States
(12) Patent Application Publication
(10) Pub. No.: US 2007/0209562 A1
(43) Pub. Date: Sep. 13, 2007

(54) Burner for furnace

(75) Inventors: John M. Lindenfelser, Northfield, MN (US); Nick P. Lindenfelser, Northfield, MN (US)

Correspondence Address: NIKOLAI & MERSEREAU, P.A., 900 SECOND AVENUE SOUTH, SUITE 820, MINNEAPOLIS, MN, 55402, US

(73) Assignee: L/MFG/E, INC., Northfield, MN (US)

(21) Appl. No.: 11/369,678

(22) Filed: Mar. 7, 2006

(51) Int. Cl. F23J 1/00; B01F 7/00; F23K 3/18

(52) U.S. Cl. 110/165 R; 110/275; 366/246

(57) ABSTRACT

An improved burner apparatus for a furnace that uses corn or other pelletized material for fuel. The apparatus includes a self cleaning rotating floor made of a generally cylindrical slowly rotating drum having a first paddle section and a second paddle section separated by an intermediate section. A plurality of paddles in each of the sections slowly rotate to control the flow of material and waste. Using this rotating floor and arrangement to aid airflow in the process of burning corn or pelletized fuel allows for effective combustion.

### BACKGROUND OF THE INVENTION

I. Field of the Invention

This invention relates generally to a burner apparatus for a furnace, and more particularly to a burner apparatus to aid in the efficient burning and combustion of corn or pelletized fuel material.

II. Discussion of the Prior Art

For many years, people have sought to improve the way various fuels, such as corn or other combustible materials, are supplied and burned in furnaces. It has long been desired to make this process as efficient as possible and to require minimal maintenance and clean-up of waste materials.

In the past, mechanisms used to aid in the burning of these types of fuels did not supply the fuel in the most effective manner for combustion. Further, even when material was supplied in an intentional fashion by movement of a mechanism such as a paddle, the surface of that mechanism would become too hot and clinker material would adhere to it. This adhesion would cause problems with combustion due to material build-up and would often prevent fuel waste from being relocated and disposed of easily. Additionally, the prior art mechanisms for moving fuel would often lack adequate airflow causing further combustion problems.

Therefore, what is needed is a mechanism enabling one to effectively and efficiently burn corn or other pelletized fuel without the combustion and waste problems of the past.

### SUMMARY OF THE INVENTION

The present invention provides for a burner apparatus for use in a furnace that has a self-cleaning, rotating floor. The floor is a generally cylindrical, slowly rotating drum having a first paddle section and a second paddle section separated by an intermediate section. Each set of paddle sections, has a plurality of paddle members having a first wall and a second wall projecting from the drum to a common edge. This configuration provides hollow chambers in the interiors of the paddle members that have openings along their outer edge to allow airflow within the chamber. Additionally, the device includes a substantially stationary scrapper located adjacent the intermediate section of the drum that cleans the drum and paddles by removing clinker material off the drum as the drum slowly rotates.

The heating device set forth in this application has wide application in a variety of devices. Some the devices in which the present invention may be used include furnaces, stoves, boilers, and room heaters.

These and other objects, features, and advantages of the present invention will become readily apparent to those skilled in the art through a review of the following detailed description in conjunction with the claims and accompanying drawings in which like numerals in several views refer to the same corresponding parts.

### DESCRIPTION OF THE DRAWINGS

FIG. 1 is a perspective view of the burner apparatus of the present invention;

FIG. 2 is a top view of the burner apparatus;

FIG. 3 is a side view of the burner apparatus;

FIG. 4 is a bottom view of the burner apparatus;

FIG. 5 is a perspective view of the burner apparatus;

FIG. 6 is a bottom view of the housing of the burner apparatus;

FIG. 7 is a perspective view of the drum and rotor member of the burner apparatus;

FIG. 8 is a top view of the burner apparatus;

FIG. 9 is a bottom view of the burner apparatus;

FIG. 10 is a perspective side view of the burner apparatus; and

FIG. 11 is a perspective view of the burner apparatus.

### DESCRIPTION OF THE PREFERRED EMBODIMENT

The present invention represents broadly applicable improvements for burner arrangements found in furnaces. The embodiments herein are intended to be taken as representative of those in which the invention may be incorporated and are not intended to be limiting.

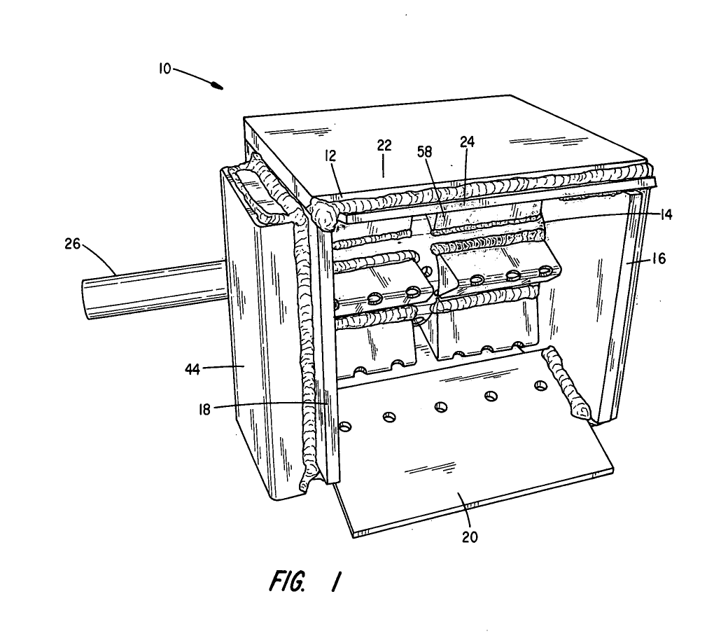

Referring first to FIG. 1, there is shown a perspective view of the burner apparatus as viewed from above. The assembly itself is indicated generally by numeral 10. The assembly has a box-shaped housing 12 with a cylindrically shaped drum 14 covered by external paddle members partially protruding from the bottom of the housing 12. The entire assembly is made of steel or other suitable material which can withstand the temperatures and stresses of the combustion process. The housing's walls include flat side wall panels 16 and 18, an intake panel 20 angled inward near its center, and a flat back panel 22 partially covered by an inwardly angled plate 24. It is within the confines of these walls that fuel such as corn or other pelletized material is fed from above for combustion. The floor of this apparatus is made up of a support drum 14 having three distinct sections on its outer surface that rotate together around the drum's central axis. The movement of this drum 14 and its sections is based upon the rotation of rotor drive shaft 26 mounted axially within the drum 14.

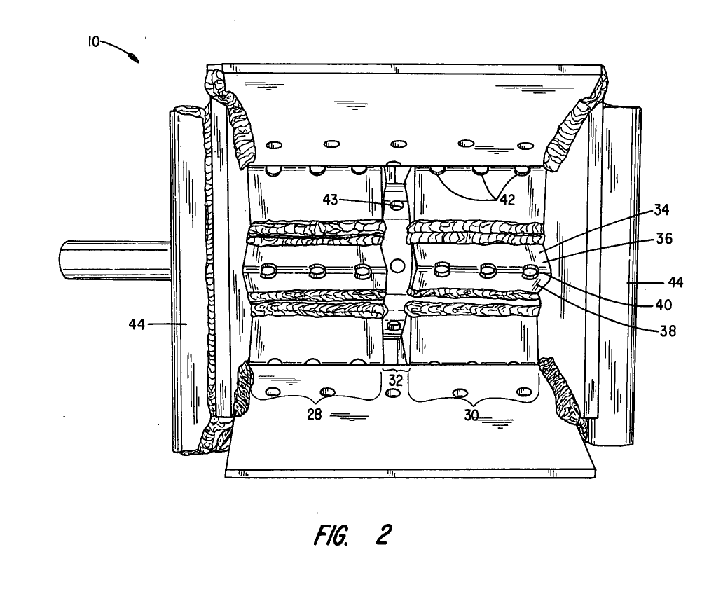

FIG. 2 shows a top view of the burner apparatus 10. From this view, the first section 28, the second section 30 and the intermediate section 32 of the apparatus's floor can be seen. The first section 28 and second section 30 are each respectively made up of eight paddle members 34, equally spaced radially about the drum. Each individual paddle member 34 has a first wall 36 and a second wall 38 projecting from the drum 14 and joined at a common edge 40. Rotational movement of these paddle members 34 aids in the movement of fuel within the combustion chamber so that new material can fall into the chamber and the ashes and waste of spent fuel will drop out of the chamber as the drum rotates into an ash pan (not shown).

The edges 40 of paddle members 34 contain a plurality of holes 42 providing air inlets and outlets so that air can pass through the paddles for cooling. This arrangement provides several benefits. First, it keeps the paddle members 34 from becoming red hot. If the paddles are too hot, clinker material will adhere to the paddle walls 36 and 38, causing problems with combustion and also preventing fuel waste from dropping into an ash pan (not shown) below the assembly. Second, the air passages also provide a source of air important for combustion of the fuel both in the main combustion chamber above the paddles and in the area immediately below the paddles so that only waste material (i.e. spent fuel) is deposited in the ash pan below the paddles when those paddles are rotated out of the combustion chamber.

Also seen in FIG. 2 are some of the center holes 43 which are found in the intermediate section 32. These holes are radially located around the outside of the intermediate section of the drum in spaced-apart relation. These holes provide a further supply of air from the open passage center of drum 14 into the combustion chamber, thereby further enhancing the efficiency of the combustion process.

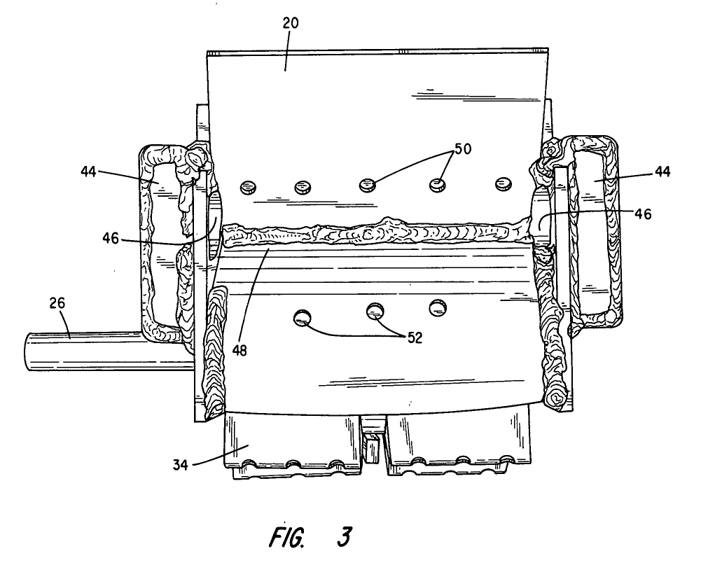

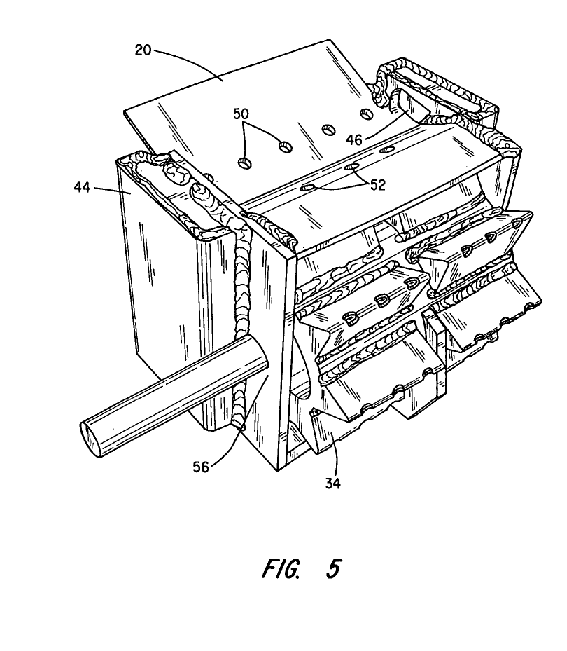

With reference to FIG. 3, the corn burner apparatus is seen from a side view revealing further features. On either side of the two flat sidewall panels 16 and 18 are metal compartments 44. These are hollow structures in which air can flow. The only openings 46 to these members are found on the faces of the compartments 44 which abut up against flat sidewalls 16 and 18. The openings are located where the compartments extend beyond the sidewalls 16 and 18 and where intake panel 20 angles inward and bends near its center at 48. (See also FIG. 5). These air passages 46 aid in cooling the device as well. Further, holes 50 are located across the top of the angled intake panel 20 for air flow and cooling. Further, holes 52 are located across the lower half of the intake panel 20 as well.

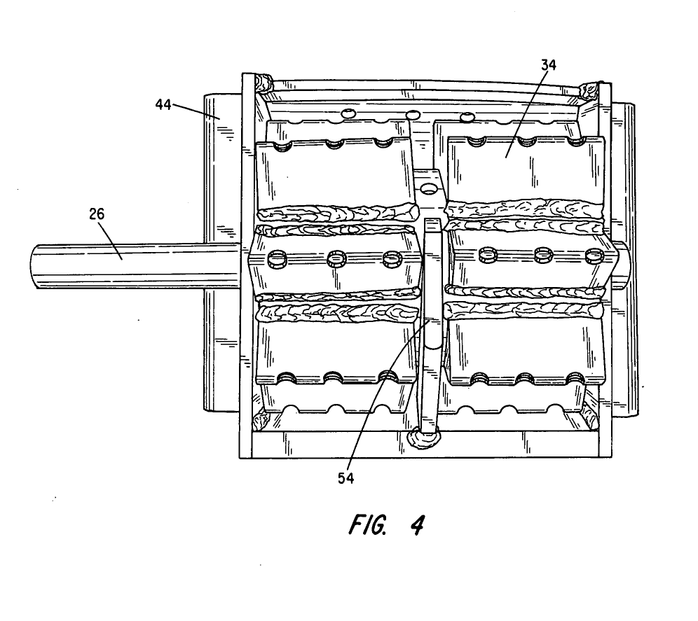

FIG. 4 shows the bottom of the burner apparatus. The paddle members 34 of the drum 14 opposite those in the combustion chamber, form the bottom face of this apparatus. The assembly also includes a scraper member 54 beneath the paddles. The scraper is generally an angled metal plate that extends down from the housing in the gap between the first and second paddle sections. The scraper is in very close proximity to the drum or in contact with the drum and paddles. The sides of the paddles and the center of the drum on the bottom side of the assembly are scraped as the drum rotates, further aiding in the removal of clinker material from the drum and paddles. The scraped material falls off the drum and paddles and into the ash bin below the device. Thus, the drum and paddles are kept clean promoting efficient combustion.

The speed at which the paddles rotate is very slow. (e.g. one revolution per twelve hours). The speed at which the paddles will rotate will vary depending upon the amount of material being burned. The more material that is burned, the faster the paddles are intended to turn.

FIG. 5 shows a perspective view of the burner apparatus. The overall shape of the assembly can be seen, including the location 56 on the lower central portion of the housing where the rotor drive shaft 26 is in rotational engagement with the housing member. The centrally spaced location of holes 50 and 52 lined horizontally across the upper and lower half of the intake panel can be seen as well.

The operation of the burner apparatus is as follows. First, a user loads the top of the furnace mounted apparatus with corn or other palletized fuel material. Next, the fuel is burned within the walls of combustion chamber above the upwardly exposed sections of the drum floor. As the furnace burns the material the drum floor and its three sections are rotated via the turning of the rotor drive shaft 26, which turns at an extremely slow rate. The ashes of the spent fuel, which fall to the floor surface, are thereby rotated out of the combustion chamber by this turning motion.

Burning and combustion is facilitated during this process as air is drawn into the combustion chamber through the holes 50 and 52 located across the upper and lower faces of the intake panel 20, as well as through holes 58 in plate 24. Air flow also is supplied through the open ends of the hollow drum that are partially exposed below the housing 12. From the inside of the hollow drum air flows into the combustion chamber directly through holes 43 in the intermediate section and via passage into the hollow interior of paddles members 34 and out holes 42. Air also flows into the assembly through openings 46 in the compartments 44 on either side of the device. All this air flow provides a continuous supply of air for the burning of fuel.

As burning of fuel is taking place in the combustion chamber on one half of drum 14, the scrapper member 54 is engaged in cleaning the other side of the drum 14 below the combustion chamber. As the drum very slowly rotates, the scrapper 54 serves as an obstruction to any material formed across the faces of aligned paddles of the first section 28 and second section 30, or within the intermediate section 32. It is able to do this as its flat plate shape fits roughly between the paddle members of the first and second sections along the intermediate section 32. The scrapper member 54 breaks off the majority of clinker material, waste material and ash that forms on the drum and paddles while in the combustion chamber. When the material breaks off it generally falls into the ash bin below the device. Therefore, operation of this design promotes effective combustion, device cooling, and a reduced need for device cleaning.

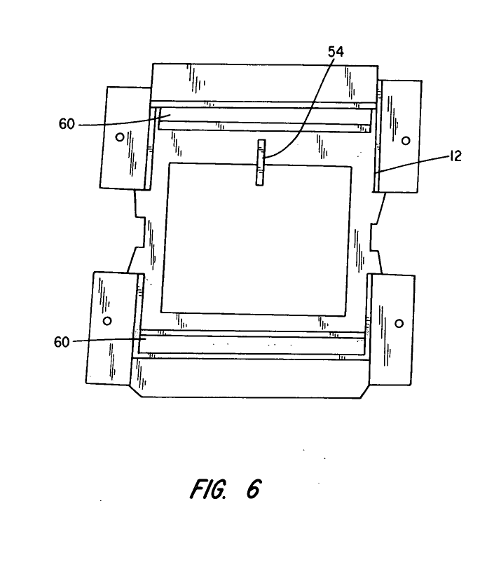

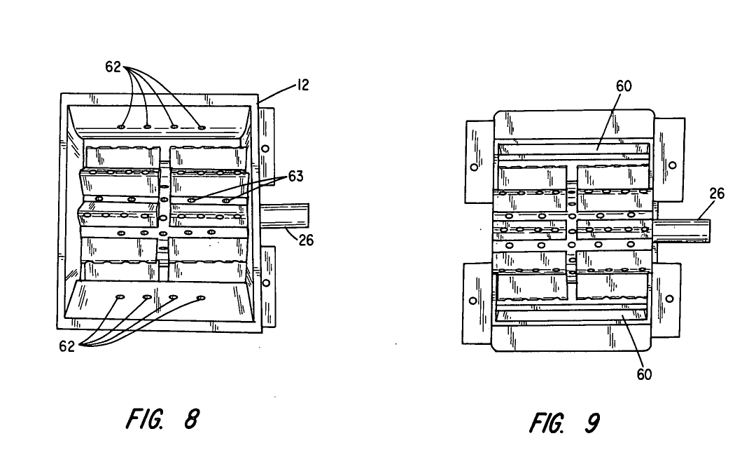

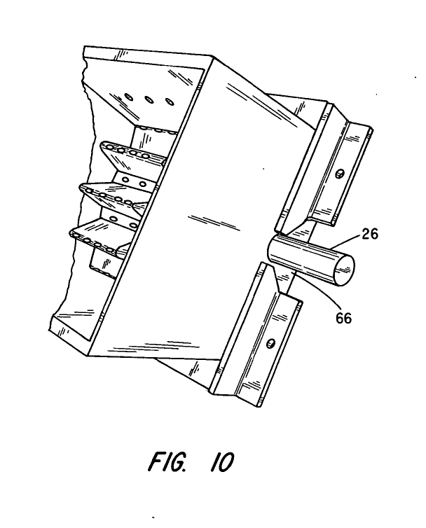

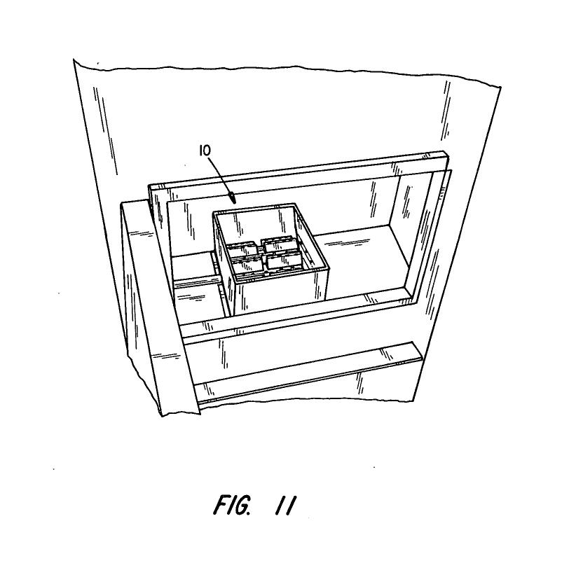

Additional improvements to this device may be seen in the embodiment shown in FIGS. 6-11. FIG. 6 generally discloses a bottom view of the burner housing 12 where the drum 14 has been removed. Additional features shown here include the passages 60 found along the ends of the housing. These passages 60 lead from the bottom of the device to the upper air holes 62 of the device seen in FIG. 8. This configuration takes on a box within a box type of structure in terms of the walls surrounding the inner combustion chamber. This configuration allows for airflow enhancing combustion within the chamber.

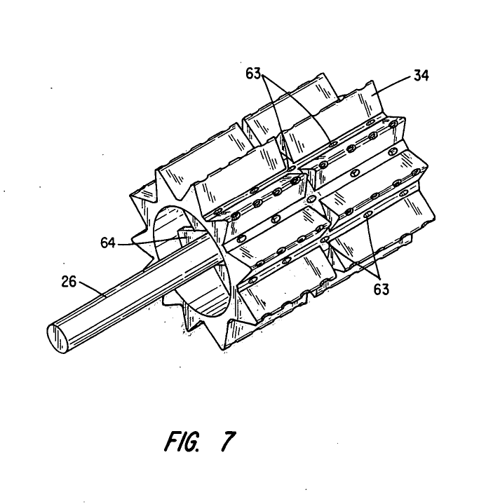

FIG. 7 shows a drum 14 and rotor drive shaft 26 which is removed from the housing of the device. The drum 14 here has eleven paddles 34 uniformly spaced around its periphery. Between these paddles members 34 are additional holes 63 which provide extra airflow from the center of the hollow drum 14. (See FIG. 8). The cross-shaped metal bars 64 on both sides of the drum can also be readily seen in FIG. 7. These bars 64 provide support between the rotor drive shaft 26 and the drum 14.

The assembled view of the device with additional improvements is seen is FIGS. 8-11. It is important to note the location 66 around the rotor shaft 26 which designates the where a support might be placed. This support generally constituting a drum retainer welded on a stove floor to support the present invention. Further, FIG. 11 shows a general perspective view of the present invention and how it can be mounted within a furnace. This invention has been defined herein in considerable detail in order to comply with the Patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A self-cleaning, rotating floor for a burner comprising:
a. a generally cylindrical slowly rotating drum of hollow interior having a first paddle section and a second paddle section, said first and second paddle sections separated by an intermediate section;
b. a first set of paddles, each paddle of said first set comprising a first wall, a second wall, said first and second walls projecting from the first paddle section of the drum to a common edge, thereby forming a hollow chamber in the interior of each paddle, the common edge of the paddle containing a plurality of apertures providing openings to cool the paddle, so that air can flow into said chamber; and
c. a second set of paddles, each paddle of said second set comprising a first wall, a second wall, said first and second walls projecting from the second paddle section of the drum to a common edge, thereby forming a hollow chamber in the interior of each paddle, the common edge of the paddle containing a plurality of apertures providing openings to cool the paddle, so that air can flow into said chamber; and
d. a substantially stationary scrapper located adjacent the intermediate section of the drum.

2. The self-cleaning, rotating floor for a burner as in claim 1 wherein the intermediate section of the drum contains apertures radially spaced about the drum.

3. The self-cleaning, rotating floor for a burner as in claim 2 wherein the rotating floor is specially adapted for combustion of corn or other pelletized fuel.

4. The self-cleaning, rotating floor for a burner as in claim 3 wherein the rotating drum is driven by a rotor drive shaft attached within the drum and centrally located on the drum axis.

5. The self-cleaning, rotating floor for a burner as in claim 1 wherein the upper half of the floor is surrounded by walls of a housing.

6. The self-cleaning, rotating floor for a burner as in claim 5 wherein the housing includes a plurality of hollow walls containing air passages and openings to access the passages

7. The self-cleaning, rotating floor for a burner as in claim 6 wherein the housing contains solid walls with openings for air flow.

8. The self-cleaning, rotating floor for a burner as in claim 7 wherein the housing contains at least one wall angled inward at its center.

9. The self-cleaning, rotating floor for a burner as in claim 1 wherein there are at least eight paddle members in the first section.

10. The self-cleaning, rotating floor for a burner as in claim 1 wherein there are at least eight paddle members in the second section.

11. The self-cleaning, rotating floor for a burner as in claim 1 wherein the paddle members are located in equivalent radial spaced apart relation.

12. A burner apparatus comprising:
a. a self-cleaning, rotating floor for a burner having a generally cylindrical slowly rotating drum of hollow interior having two paddle sections separated by an intermediate section wherein the two paddle sections are comprised of a plurality of paddle members each having a first wall and a second wall projecting from the drum to a common edge and a substantially stationary scrapper located adjacent the intermediate section of the drum;
b. a rotor drive shaft axially aligned and centrally located and supported within the drum; and
c. a housing in rotational engagement with the rotor drive shaft on both sides of the drum and surrounding the top half of the rotating floor.

13. The burner apparatus as in claim 12 wherein the paddle members of the rotating floor contain holes along their common edges.

14. The burner apparatus as in claim 13 wherein additional wall members are attached to the sides of the housing and contain air passages for cooling the apparatus.

15. The burner apparatus as in claim 12 wherein the paddle members are located in equivalent radial spaced apart relation.

16. The burner apparatus as in claim 12 wherein the housing includes a plurality of walls containing air passages and openings to access the passages
